(19) United States
(12) Patent Application Publication
(10) Pub. No.: US 2016/0342939 A1
(43) Pub. Date: Nov. 24, 2016

(54) METHOD AND APPARATUS FOR UTILIZING CUSTOMER ACTIONS FOR STORE INTELLIGENCE AND MANAGEMENT

(71) Applicant: Wal-Mart Stores, Inc., Bentonville, AR (US)

(72) Inventors: Nicholaus A. Jones, Fayetteville, AR (US); Robert J. Taylor, Rogers, AR (US); Matthew A. Jones, Bentonville, AR (US); Aaron J. Vasgaard, Rogers, AR (US)

(21) Appl. No.: 15/155,676

(22) Filed: May 16, 2016

Related U.S. Application Data
(60) Provisional application No. 62/165,857, filed on May 22, 2015.

(51) Int. Cl. G06Q 10/08

(52) U.S. Cl. CPC G06Q 10/087

(57) ABSTRACT

In some embodiments, systems, apparatus and methods are provided herein useful to improve store management. These utilize customer actions to provide or obtain store intelligence and/or improve store management so that store associates are freed-up to do other tasks (e.g., help customers) and reduce risk of human error. In one form, the system includes a control circuit configured to receive data obtained by a customer in the retail sales environment, the data obtained from an asset identifier associated with a given product or product display, and process the obtained data and update store systems or records regarding same. In some embodiments, additional action may be taken in response to the received or processed data.

### CROSS-REFERENCE TO RELATED APPLICATION

This application claims the benefit of U.S. Provisional Application No. 62/,165,857 filed May 22, 2015, which is incorporated herein by reference in its entirety.

### TECHNICAL FIELD

This invention relates generally to retail store management and, more particularly, to systems, apparatus and methods for improving store management.

### BACKGROUND

Some primary objectives of conventional retail stores are to provide consumers with the items they need and to do so efficiently so as to maximize sales. One of the leading causes of lost sales is a lack of product availability, and another leading cause is some problem or error associated with displayed product. Current retail systems rely heavily on associate activity to place, check, count and replenish displayed product, (e.g., product on shelves, in end units, in features, modulars, etc.), which is both costly and prone to errors. Stores could operate more efficiently if these associates were freed up to do other tasks.

An example of some of the work an associate may be asked to do is to place features or modulars on the retail store floor by a particular date so that a certain target selling period for the displayed item is met (e.g., getting a new book, movie, game or other product out on the sales floor by a release date for this product). Once done, an associate or employee is asked to confirm compliance by reporting that the feature is on the floor. Then, after the target selling period, the associate is requested to remove the features or modulars and confirm same. In another example, associates may be requested to place new products items on display for sale in the store and then report the completion of this task. All of these activities take up time that the associate could be spending elsewhere completing other tasks, such as assisting store customers, etc., and leave open the risk for human error which could actually cause extra work for associates (e.g., requiring additional checks and reports on the display or display compliance because an error occurred in the initial reporting of same, etc.).

In addition, over the past several years, the amount of consumers who utilize mobile devices during their shopping experience has dramatically increased. For example, some consumers use smartphones during their shopping experience to conduct price checks, do competitive shopping analysis, obtain further product information, make the shopping experience more efficient such as by expediting checkout (e.g., Wal-Mart Scan & Go system), etc. Other consumers may utilize store provided electronics, such as scanners or the like, that allow the consumer to obtain more information about their shopping or during their shopping experience and/or to make their shopping experience more efficient, such as by expediting checkout, etc. Conventional retail stores have not taken full advantage of this increased use of technology by consumers.

Accordingly, it has been determined that a need exists for improved systems, apparatus and methods for managing stores to overcome the above-mentioned problems.

### BRIEF DESCRIPTION OF THE DRAWINGS

Disclosed herein are embodiments of systems, apparatuses and methods pertaining to retail store management and improving same. This description includes drawings, wherein:

FIG. 1 is a flow diagram of a general process in accordance with some embodiments.

FIG. 2 is a diagram of a system in accordance with several embodiments.

FIG. 3 is a diagram of an off-site system in accordance with some embodiments.

FIG. 4 is a flow diagram of another process in accordance with several embodiments.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatus and methods are provided herein useful to improve store management and address the problems or shortcomings with conventional stores discussed above. In some embodiments , a method for monitoring a plurality of product display units in a retail sales environment is performed by a control circuit and includes the steps of: receiving data obtained by a customer in the retail sales environment, the data obtained from an asset identifier associated with a given product display unit; and processing the obtained data relative to corresponding data stored in a product display unit database maintained by a retail sales entity and containing data associated with each of the plurality of product display units.

In some embodiments, systems, apparatus and methods are disclosed that utilize customer actions to provide or obtain store intelligence and/or improve store management so that store associates can focus on/complete other tasks/priorities (e.g., helping customers) and reduce the risk that human error causes extra work for store associates (e.g., double-checking a feature or modular set that was not confirmed appropriately). For example, customer actions and data may be used to determine the presence and/or time and/or sales floor locations of new items and/or confirm the same for displayed product or product display units (e.g., product on shelves, in end units or product features, etc.) or identify the need to check or replenish such product display units. Thus, reducing the amount of associate time and work required to confirm when features or new items and modulars have been set on the sales floor in compliance with store policy and/or the amount of associate time and work required to check such product displays or product display units and request replenishment of same. In addition, by automating these processes, the risk of human error associated with same has been reduced.

In one form, the customer actions and data are integrated into and interact with the store inventory management system so that confirmation of new item placement and product, modular and/or feature sets are automatically made without the need for an associate to report same. More particularly, an asset identifier (e.g., a QR code, bar code, NFC communication, etc.), is associated with a store item (e.g., new product, on-shelf item, modular, feature, etc.) to draw attention to new and featured items as well as promote sales through incentives with customers/consumers. In one form, the asset identifier may be scannable and placed on or near the store item. When the item is scanned, data is provided to a system that tracks these scans and may communicate with other store systems to automatically confirm that a new item, modular or feature has been set and is present on the sales floor. This information could enable functions within the store's inventory management system to activate for the new items. The asset identifier may take many different forms. For example, in some forms the identifier may be any interactive feature that a consumer uses to interact with the product or display.

In some instances, an incentive may also be provided to encourage the consumer's participation or interaction with the system, such as offering a coupon, recipe, further product information, multi-media (e.g., audio or video such as game or movie trailers), early release access, upcoming product information, online add-ons (e.g., unlocking skins, characters, weapons, levels, worlds or the like for games, etc.), or other value-add services. For example, in one form of incentive, a scavenger hunt game may be utilized to prompt and/or encourage consumers to make scans of multiple products or displays to provide additional information to the system regarding other products or displays (e.g., such as their placement, location, status of stocked product, etc.). Making the shopping experience a game in this way (e.g., gamification of the shopping experience) may also increase sales by directing some consumers to products that they might not otherwise look or ask for while doing their normal course of shopping.

Using customer actions in this way could provide additional data or intelligence to the retailer that might not be otherwise known. For example, the timestamp of the scan could be used to see or determine customer engagement and traffic regarding the display. In addition, the timestamp and quantity of scans could be used to determine pick-ups and put-backs regarding the display, as well as inform on the effectiveness of the display or incentive associated with same. In stores that direct consumer traffic or flow (e.g., race-track type layouts or flow paths), gamification of the shopping experience in this way would allow the consumer data collected to be used as an alternate or additional means to determine product availability in the display (e.g., on shelf, end cap, modular or feature). Use of consumer provided information in this way reduces systematic work required of the store associates to place new product or set new items, modulars and features, and enables quality controls and/or compliance of same in accordance with recommended placement or set-dates by store management.

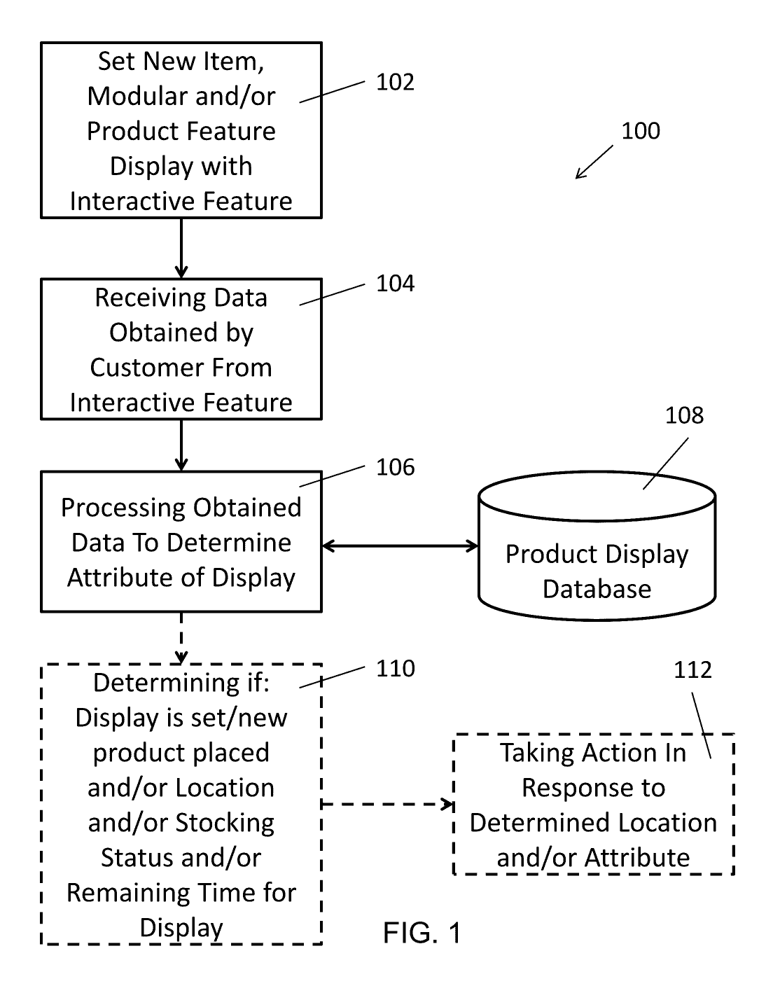

Turning now to the drawing figures, FIG. 1 illustrates a flow diagram of a general process in accordance with some embodiments of the invention. The process is referred to generally by reference numeral 100 and includes a first step 102 wherein a customer is prompted to obtain data from an asset identifier associated with a product display unit. For example, a new product may be placed on the sales floor or in the store and/or a new display may be set (e.g., on store shelf, in end unit, in modular, in feature, etc.) with an asset identifier which a consumer may use to identify or interact with the display. In a preferred form, the consumer will scan the asset identifier to contact or provide information to a control circuit, such as a computer system. The system then receives the data obtained by the customer from the asset identifier in step 104, and processes the obtained data to determine some information or intelligence relating to the display (e.g., an attribute of the display) in step 106. In a preferred form, a control circuit accesses a product display unit database in step 108 and processes the data obtained from the customer relative to the data from the product display unit database in step 106. The actual processing done can vary. For example, processing could simply mean comparing two data points to see if they match. Alternatively, it could simply mean checking to see if a record was already updated to reflect the placement of a new product or setting of a new display and updating the record accordingly if it has not already been done. In yet other forms, processing may entail updating other retail store systems with the information obtained from the consumer. It also should be understood that the database may be configured as a database structured into a plurality of different files or, alternatively, may be structured into a single file if desired.

The process 100 can be setup to operate in a variety of ways upon processing the information from the customer in step 106. For example, in one form and as indicated in step 110, the process may simply be used to make a determination based on the processing of step 106. For example, the process may simply be used to determine if the new product has been placed and/or if the product display unit has been set. Alternatively or in addition and as mentioned above, the system may further be used to determine location of the display and/or the stocking status of the display (e.g., does it need to be restocked, does historical data indicate it will need to be restocked within a certain amount of time, does the inventory management system indicate it is scheduled for restocking or a product delivery within a certain period of term, etc.). Alternatively or in addition, the system may be used to determine the remaining time left for the displayed item so that the management system can be alerted to the need to remove or replace the display. This step may also entail updating store systems or records with the determined information (e.g., enabling functions within a store inventory management system to activate for the new items or display now that they have been confirmed to be on the sales floor or in the store).

In addition to the system operation options identified in step 110, the system may also be configured to take action in response to the consumer data or determination made based on the processing. For example, as illustrated in step 112, the system may be configured to take some form of action in response to the data, such as initiating a restocking request, a check display request, a remove display request, updating other store systems, messaging associates or management of any of the above, etc. By utilizing the customer provided data in this way, the system is capable of being used in a variety of different ways or provided with different options. For example, in one form the system could be used passively to simply confirm that a new product has been placed on the sales floor or that a particular product display unit (e.g., shelving unit, end cap or unit, module, feature, etc.) has been set. In another form, the system could be utilized passively to obtain or provide management with additional data or intelligence regarding consumers, their shopping habits and information regarding the store's own displays and inventory of same. In still other forms, the system could be utilized more actively to provide its own notifications or alerts to ensure available product is stocked and on-hand in the desired displays, or to generate reports regarding any of the above mentioned information. All of the above should help increase sales and free-up associates to conduct other tasks (e.g., assist customers, located requested products, etc.).

In still other forms, the system may also be configured to provide an incentive to the customer as indicated in step 111 to incentivize the customer to provide the data of steps 102 and 104. For example and as mentioned above, the system may be configured to entice the customer to participate in the program or provide the sought after information by offering a value-add incentive, such as offering a coupon, recipe, further product information, multi-media (e.g., audio or video such as game or movie trailers), early release access, upcoming product information, online add-ons (e.g., unlocking skins, characters, weapons, levels, worlds or the like for games, etc.), or other value-add items or services.

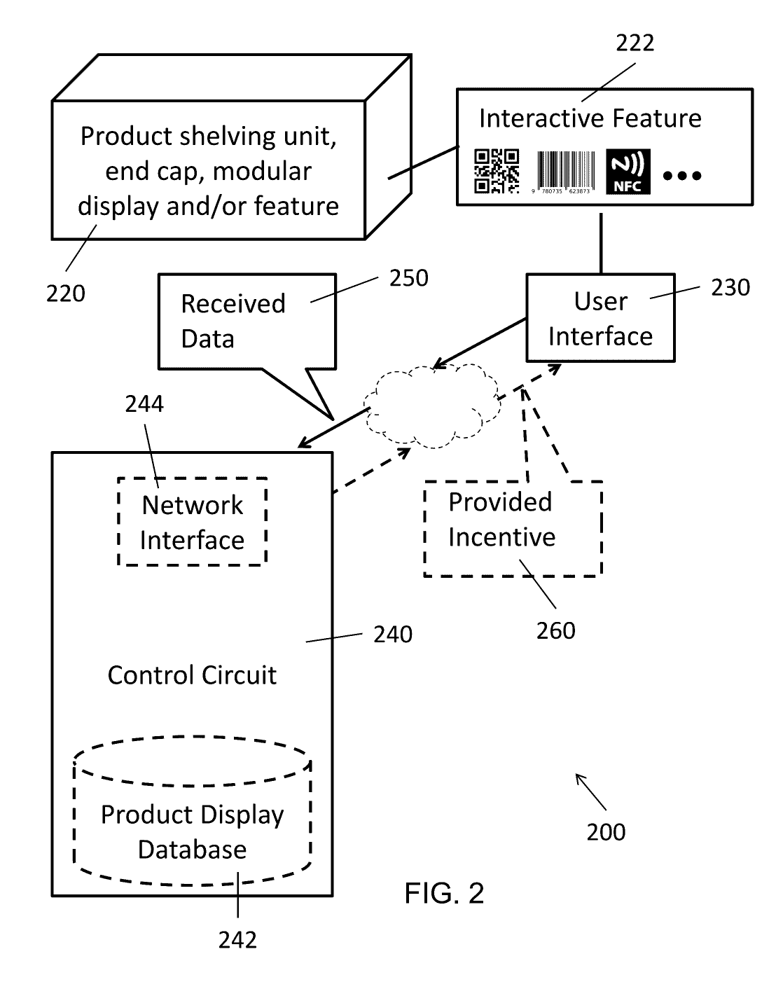

An exemplary system in accordance with several embodiments of the invention is disclosed in FIG. 2 and referenced generally as system 200. In the form illustrated, the system includes a product or product display unit 220, (e.g., product shelving, end cap, module, feature, etc.), which is capable of displaying one or more products in a retail sales environment. The product or product display unit 220 preferably includes an asset identifier 222. The asset identifier 222 could be a passive item such as a quick response (QR) code, bar code (e.g., UPC or GTIN12, EAN or GTIN13, etc.), radio frequency identification (RFID) tag, passive camera, etc., or alternatively, could be an active item such as near field communication (NFC) tag, active RFID tag, Bluetooth device, active camera, etc. The asset identifier 222 acts as an asset ID so that when a consumer uses a user interface 230 to capture or interact with the asset identifier 222 and deliver information about the display product unit 220, the system 200 will be able to determine what display product unit 220 the data relates to in the store. In a preferred form, the asset identifier 222 is located on the display 220, however, in alternate embodiments the asset identifier 222 may be disposed proximately to the given product display unit 220.

The user interface 230 may be any portable or handheld processor based device (e.g., smartphone, phablet, tablet, laptop computer, wearable device, etc.), but preferably will be a smartphone, phablet, tablet, wearable computing device (e.g., smartglasses, smartwatch, etc.) or the like that a user uses to interact with the asset identifier 222. In some forms, the user interface 230 may have stored in its memory device a software application (e.g., an App, camera software, etc.) that is executable by the user interface's processor to communicate with system 200. In alternate forms, the store may provide the user with a store supplied device such as a scanner that is capable of communicating with the system 200, but a bring your own device (BYOD) system is preferred.

The system 300 further includes a control circuit 240 which may be any processor based device, such as a computer system, located on-site (e.g., on store premises) or off-site (e.g., off store premises at a remote location such as company headquarters, cloud based, etc.), or that has functional assets both on-site and off-site. The network may be a wide-area network (WAN), a local area network (LAN), a personal area network (PAN) or any other sized network. In some forms, the network will communicate via the Internet and may include cloud-based features, such as cloud-based memory storage, etc. Actual communications or portions thereof may take place over hard-wired, cellular, Wi-Fi or Bluetooth networked components or the like.

In the form illustrated, the control circuit 240 includes a product display unit database 242 and a network interface 244 to allow the control circuit 240 to receive data from the user interface 230. As mentioned above, the database 242 may be made-up of a plurality of individual files or simply contain one large file if desired. In a preferred form, the control circuit 240 receives data 250 obtained by the customer in the retail sales environment associated with a given product display unit, (e.g., the data obtained from the asset identifier 222), and processes the obtained data 250 relative to corresponding data stored in the product display unit database 242 maintained by the retail sales entity and containing data associated with each of the plurality of product display units. In the form illustrated, processing the obtained data 250 comprises comparing and matching the obtained data 250 and the data stored in the product display unit database 242 and taking an action based on whether or not the obtained data matches the data stored in the product display unit database.

The data stored in the product display unit database 242 preferably includes information relating to one or more products and/or displays (or display units), a desired location of the one or more products and/or displays in the retail sales environment and/or information relating to a desired display date for the one or more products and/or displays in the retail sales environment. In alternate forms, the system database 242 may include other store systems or interaction with same, such as to provide information regarding an attribute of the display 220. For example, the data may include information relating to inventory or interact with an inventory management system (e.g., generate restocking requests, pick requests, etc. based on information received from the customers).

As mentioned above, the system 200 may also be configured to have the controller 240 take action in response to the receipt of information from the consumer. For example, in one form, the control circuit 240 may transmit an incentive 260 to the customer. The incentive would be a reward capable of incentivizing the consumer to provide the data 250 to system 200 (e.g., to incentivize scanning of the asset identifier 222 in exemplary embodiments where scanning is how the data 250 is obtained). In some forms, the incentive 260 may be a coupon or rebate. In other forms, the incentive 260 may be one or more of a recipe, further product information, multi-media file (e.g., audio or video file such as game or movie trailers), early release access, upcoming product information, online add-ons (e.g., unlocking skins, characters, weapons, levels, worlds or other items for games, etc.), or other value-add services.

In some forms, it may be desired to get the customer/consumer to send in data on multiple displays within the same store or part/region of store, (e.g., department, category, sub-category, etc.) to provide additional information or intelligence to system 200. For example, in one form, the customer is prompted to scan a plurality of the product display units located about the store as part of a customer participation game (e.g., the above-mentioned gamification of the shopping experience). In one exemplary embodiment a scavenger hunt type game is played or mimicked by requiring the consumer to locate different displays or display units and send in data relating to same while at each display or after having visited each display or display unit. This information may be used to confirm placement of new product, setting of displays, location of said products or displays, display or product attributes (e.g., such as stock status, expected time until display is empty, etc.), or other intelligence (e.g., typical flow, flow pattern, effectiveness of display, effectiveness of incentive, etc.). For example, the customer provided data may not only confirm that a new product is out on the store shelf, floor or display or that a new display is set, but location services data relating to the customer or user interface 230 may confirm the location of the new product or display. In other forms, instead of (or in addition to) using the customer's device to get location data, the sequence of the scan can be used to derive location of the product, display, etc. (e.g., the customer scans one display first, then a second display next, then a third display after that, etc.). Alternatively, the customer provided data may confirm that the display or product is in the desired location during an intended period of time (e.g., confirming Halloween displays are out and located where desired during Halloween period, Christmas displays are out and located where desired during the Christmas period, etc.). This information can help the retailer ensure compliance with management instructions, requests or guidelines.

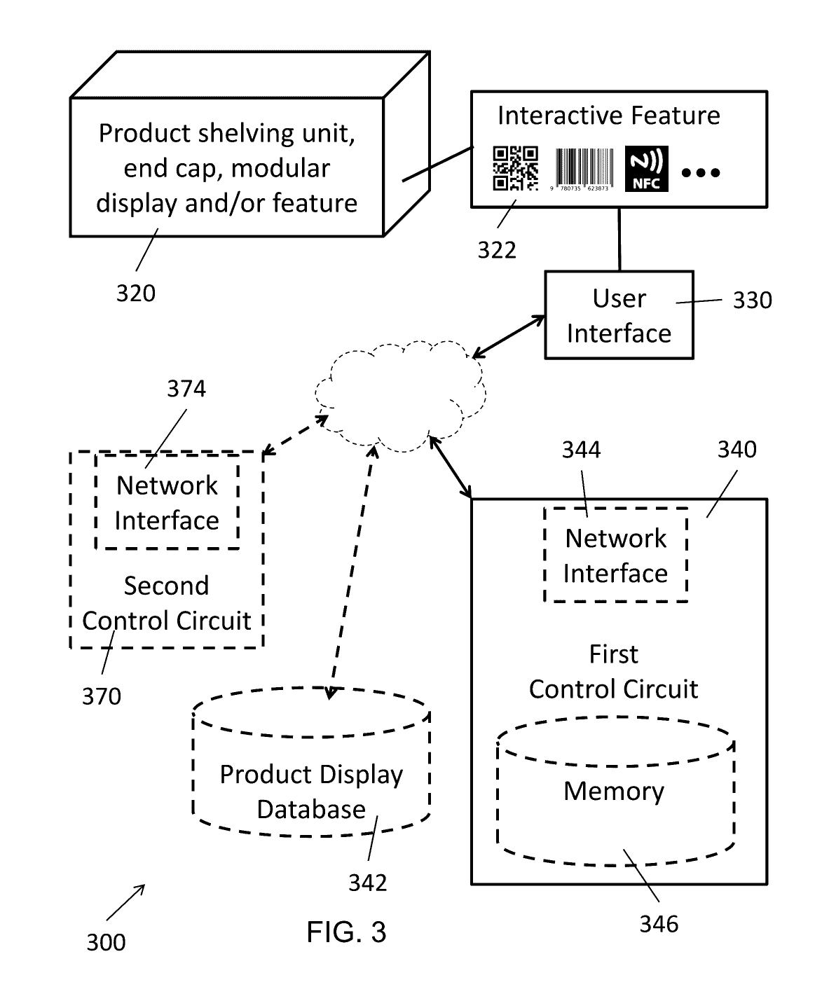

An alternate system is illustrated in FIG. 3 and is referred to generally by reference numeral 300. Items in the drawings that are similar to those discussed above with respect to system 200 use similar latter two-digit reference numerals, but use a different prefix number to distinguish one embodiment from others. For example, in FIG. 3, similar items will use the same latter two digit reference numeral, but add the prefix 3 instead of 2 to distinguish the embodiment of FIG. 3 from the embodiment of FIG. 2 (hence, why the system is referred to generally as system 300, rather than system 200). In the form illustrated, the system 300 includes an apparatus for monitoring a plurality of product display units 320 in a retail sales environment and has a control device comprising a control circuit 340 and a memory or memory device 346. The system further includes a product display unit database 342 accessible by the control circuit 340, which is maintained by the retail sales entity (e.g., directly by the entity or via a service used by the retail sales entity) and contains data associated with each of the plurality of product display units 320.

The system 300 further includes a network interface 344 coupled to the control device 340 wherein the network interface is configured to receive data obtained by a customer in the retail sales environment (via the user interface 330), the data obtained from an interactive feature, such as asset identifier 322, which is associated with a given product display unit 320 (e.g., new product item, shelf display, end cap, modular, feature, etc.). In this form, the control circuit 340 is configured to process the obtained data relative to corresponding data stored in the product display unit database 342. In one form, processing the obtained data comprises comparing and matching the obtained data and the data stored in the product display unit database 342 and taking an action based on whether the obtained data matches the data stored in the product display unit database 342. In some forms processing may further entail updating other store systems or records based on the received information (e.g., enabling functions within a store inventory management system to activate for the new items or display now that they have been confirmed to be on the sales floor or in the store).

The asset identifier 322 is disposed proximate to the product display unit 320 and the data stored in the product display unit database 342 includes information relating to an attribute of a product or display unit (e.g., placement of a new product item or setting of a product display unit, location of the new product or display unit, stock status of new product or display unit, time period for which new product or display are to be on sales floor, length of time until new product or display is out of product, etc.).

The system 300 may be configured to prompt the customer to scan at least one of a plurality of product items or product display units 320. In addition, and as mentioned with earlier systems and processes, system 300 may be configured to transmit an incentive to the customer after receiving the data obtained by the customer via the network interface 344. In other forms, the system 300 may be configured to prompt or incentivize the customer to scan a plurality of items or product display units 320 to gain further information or intelligence for store management.

The system 300 may be configured so that the displays 320 and control circuit 340 are located on-site at the retail store facility. For example, in the illustrated embodiment, the control circuit may be a central computer system located on premises. In fact, the product display database 342 may be stored within the memory 346 of control circuit 340. Alternatively, however, portions of the system 300 may be located off-site or remotely. For example, the product display database 342 may be stored in cloud-based storage located remotely from the on-site computer system 340 but in communication with or accessible by same. In still other forms, the control circuit 340 may be a central computer system located off site, such as at company headquarters or at a central corporate processing center. In yet other forms, the control circuit 340 may be a first control circuit located remotely from the facility containing the display 320 and/or may include a second control circuit 370 located elsewhere (either on-site or off-site from the facility containing the display unit 320) that helps perform the functions of system 300. For example, the consumer may transmit his or her data (e.g., the customer or consumer provided data) to an intermediary control circuit 370, such as an initial computer system located on-site with the display unit 320, which then communicates the data to one or more remote locations containing the primary control circuit 340 and/or product display unit database 342. Such a system may be configured with the display unit 320 located in a retail sales facility or establishment and the primary control circuit 340 located at a central location remote from the retail sales facility.

Any of the above-mentioned exemplary embodiments may be partially or fully combined with one another to form further embodiments contemplated within the scope of the invention. For example, based on the above, an apparatus for monitoring a plurality of product display units in a retail sales environment is disclosed herein having an interface with an input and an output, and a control circuit coupled to the interface configured to: receive data scanned by a customer in the retail sales environment, the data scanned from an asset identifier associated with a given product display unit; and process the scanned data relative to corresponding data stored in a product display unit database maintained by a retail sales entity and containing data associated with each of the plurality of product display units.

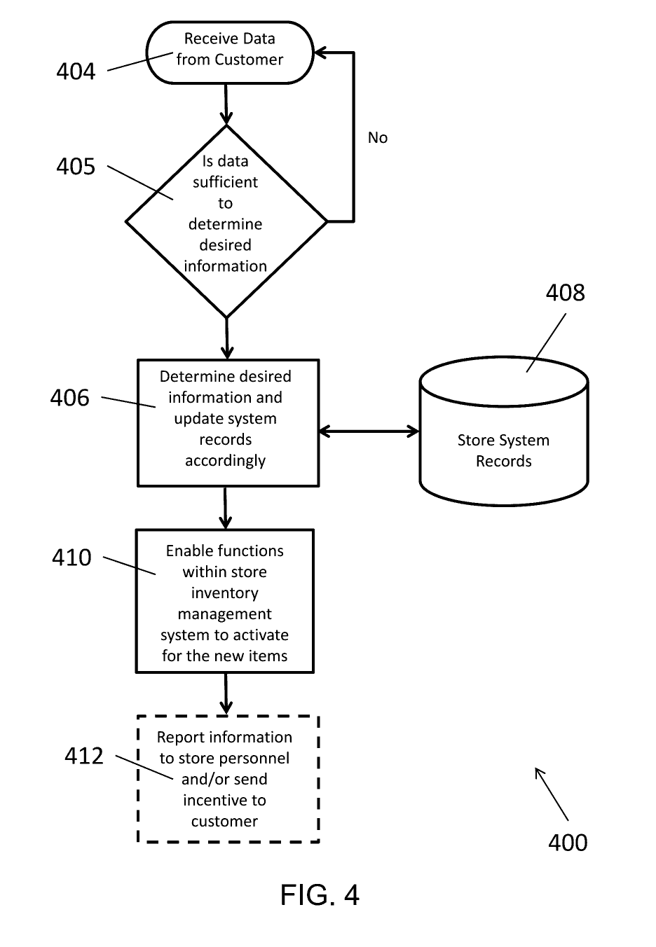

In addition, while general processes have been described above with respect to FIG. 1, it should be understood that control circuits may be configured to perform more detailed processes in accordance with the above disclosure. For example, an alternate more specific process in accordance with embodiments of the invention is illustrated in FIG. 4 and referenced generally by reference numeral 400. As with prior embodiments, similar processes will use the same latter two-digit reference numeral but be with the prefix 4 to distinguish embodiments. In this illustrative example, an apparatus or system is provided that with a control circuit and a non-transitory computer readable memory storing a set of instructions executable by the control circuit and configured to cause the control circuit to perform the steps of FIG. 4. More particularly, in step 404 the control circuit may be configured to receive data from the customer or consumer. In step 405, if the data is not sufficient for the control circuit to determine desired information or at least determine the desired information with a threshold amount of certainty, the control circuit reverts back to step 404 and continues to look for and receive data from customers. If the amount of data is sufficient to determine desired information with a threshold amount of certainty, the control circuit determines or processes the desired information and updates system records accordingly in step 406. During the processing of step 406, the control circuit may be configured to communicate with store systems, such as product display database 408, to either obtain information from same, to conduct comparative analysis or to interact with these store systems and update the records thereof. Once processing step 406 is complete, in step 410 the control circuit may be configured to enable functions within store systems, such as a store inventory management system, to activate these functions for the new items detected via the processing stage. In some forms, the control circuit may also be configured to take further action in response to the determination made via processing step 406. For example, in step 412 the control circuit may be configured to send an incentive to the customer who supplied the data to reward them for supplying this information or incentivize them to provide this information and/or may be configured to report information to store personnel in response to the determinations made during the processing step 406. Thus, system 400 may be utilized passively to simply confirm placement of product or setting of product displays. Alternatively, system 400 may be used to update store systems with further information obtained from the customer provided data (e.g., location of newly placed item or newly set display, stocking information or other product/display attributes). In still other forms, system 400 may be utilized more actively by taking action in response to the received or processed customer supplied data, such as issuing incentives, reports, alerts or the like. The incentives may even increase sales by getting consumers to try new products or visit new displays that they otherwise would not have visited.

Several embodiments are provided herein that include systems, apparatus and methods useful to improve store management. In some embodiments, a method for monitoring a plurality of product display units in a retail sales environment is performed by a control circuit and includes the steps of: receiving data obtained by a customer in the retail sales environment, the data obtained from an asset identifier associated with a given product display unit; and processing the obtained data relative to corresponding data stored in a product display unit database maintained by a retail sales entity and containing data associated with each of the plurality of product display units.

In some embodiments, a system for monitoring a plurality of product display units in a retail sales environment comprises: a control device comprising a control circuit and a memory; a product display unit database accessible by the control circuit, maintained by a retail sales entity and containing data associated with each of the plurality of product display units; and a network interface coupled to the control device. The network interface is configured to receive data obtained by a customer in the retail sales environment, the data obtained from an asset identifier associated with a given product display unit. And the control circuit is configured to process the obtained data relative to corresponding data stored in the product display unit database.

In some embodiments, an apparatus for monitoring a plurality of product display units in a retail sales environment comprises: an interface having an input and an output; and a control circuit coupled to the interface. The control circuit is configured to: receive data scanned by a customer in the retail sales environment, the data scanned from an asset identifier associated with a given product display unit; and process the scanned data relative to corresponding data stored in a product display unit database maintained by a retail sales entity and containing data associated with each of the plurality of product display units.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A method for monitoring a plurality of product display units in a retail sales environment comprising:
by a control circuit,
receiving data obtained by a customer in the retail sales environment, the data obtained from an asset identifier associated with a given product display unit; and
processing the obtained data relative to corresponding data stored in a product display unit database maintained by a retail sales entity and containing data associated with each of the plurality of product display units.

2. The method of claim 1, wherein the asset identifier is disposed proximally to the given product display unit.

3. The method of claim 1, wherein the given product display unit comprises at least one of a product feature unit, a shelving unit, a modular display unit, and an end cap display unit located near an end of a product display aisle.

4. The method of claim 1, wherein the data stored in the product display unit database comprises information relating to a desired location of one or more of the plurality of product display units in the retail sales environment.

5. The method of claim 1, wherein the data stored in the product display unit database comprises information relating to a desired display date for one or more of the plurality of the product display units in the retail sales environment.

6. The method of claim 1, further comprising transmitting, after the receiving the data step, an incentive to the customer.

7. The method of claim 1, further comprising prompting the customer to scan at least one of the plurality of product display units.

8. The method of claim 7, wherein the customer is prompted to scan a plurality of the product display units as part of a customer participation game.

9. The method of claim 7, wherein the customer is prompted to scan at least one of the plurality of product display units located in a particular region of the retail sales environment.

10. The method of claim 1, wherein processing the obtained data comprises comparing and matching the obtained data and the data stored in the product display unit database and taking an action based on whether the obtained data matches the data stored in the product display unit database.

11. The method of claim 1 wherein the processing verifies that the given product display unit is at a desired region of the retail sales environment.

12. The method of claim 1 wherein the processing verifies that the given product display unit is in the retail sales environment during an intended time period.

13. A system for monitoring a plurality of product display units in a retail sales environment comprising:
a control device comprising a control circuit and a memory;
a product display unit database accessible by the control circuit, maintained by a retail sales entity and containing data associated with each of the plurality of product display units; and
a network interface coupled to the control device;
wherein the network interface is configured to receive data obtained by a customer in the retail sales environment, the data obtained from an asset identifier associated with a given product display unit; and
wherein the control circuit is configured to process the obtained data relative to corresponding data stored in the product display unit database.

14. The system of claim 13, wherein the asset identifier is disposed proximally to the product display unit.

15. The system of claim 13, wherein the product display unit comprises at least one of a product feature unit, a shelving unit, a modular display unit, and an end cap display unit located near an end of a product display aisle.

16. The system of claim 13, wherein the data stored in the product display unit database comprises information relating to a desired location of one or more of the plurality of product display units in the retail sales environment.

17. The system of claim 13, wherein the data stored in the product display unit database comprises information relating to a desired display date of one or more of the plurality of product display units in the retail sales environment.

18. The system of claim 13, wherein the control circuit is further configured to transmit an incentive to the customer after receiving the data obtained by the customer via the network interface.

19. The system of claim 13, further being configured to prompt the customer to scan at least one of the plurality of product display units.

20. The system of claim 13, wherein processing the obtained data comprises comparing and matching the obtained data and the data stored in the product database and taking an action based on whether the obtained data matches the data stored in the product display unit database.

21. The system of claim 13, wherein the control device is implemented and located in at least one of the retail sales facility and a central location remote from the retail sales facility.

22. An apparatus for monitoring a plurality of product display units in a retail sales environment comprising:
an interface having an input and an output; and
a control circuit coupled to the interface;
wherein the control circuit is configured to:
receive data scanned by a customer in the retail sales environment, the data scanned from an asset identifier associated with a given product display unit; and
process the scanned data relative to corresponding data stored in a product display unit database maintained by a retail sales entity and containing data associated with each of the plurality of product display units.

23. An apparatus for monitoring a plurality of product display units in a retail sales environment comprising:
asset identifier means for identifying a given product display unit;
means for receiving data obtained by a customer in the retail sales environment, the data obtained from the asset identifier means; and
means for processing the obtained data relative to corresponding data stored in a product display unit database maintained by a retail sales entity and containing data associated with each of the plurality of product display units.
